(19) United States
(12) Patent Application Publication
(10) Pub. No.: US 2011/0035349 A1
(43) Pub. Date: Feb. 10, 2011

(54) Knowledge Management Environment

(75) Inventors: Donald R. Kretz, Plano, TX (US); Robert A. Butler, IV, Lewisville, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/537,433

(22) Filed: Aug. 7, 2009

(51) Int. Cl. G06N 5/02

(52) U.S. Cl. 706/48

(57) ABSTRACT

According to one embodiment, a computer-readable medium has computer-executable instructions that, when executed by a computer, are configured to define a plurality of management services according to a model. The model structures operations among the plurality of management services according to a knowledge configuration. A knowledge service is defined according to the model. The model assigns the knowledge service to a knowledge store according to the knowledge configuration. The knowledge store contains a plurality of data records. Instances of the plurality of management services are created. The instances of the plurality of management services control access to the knowledge store. An instance of the knowledge service is created. The instance of the knowledge service performs operations on the data records.

### TECHNICAL FIELD

This invention relates generally to the field of computer programming and more specifically to a knowledge management environment.

### BACKGROUND

In the context of enterprise architecture, a service is a defined set of contiguous and autonomous business or technical functionality. Service-orientation is a design paradigm that specifies the creation of automation logic using services. Service-orientation may be applied in developing a service-oriented architecture, which provides methods for system development and integration.

### SUMMARY

According to one embodiment, a computer-readable medium has computer-executable instructions that, when executed by a computer, are configured to define a plurality of management services according to a model. The model structures operations among the plurality of management services according to a knowledge configuration. A knowledge service is defined according to the model. The model assigns the knowledge service to a knowledge store according to the knowledge configuration. The knowledge store contains a plurality of data records. Instances of the plurality of management services are created. The instances of the plurality of management services control access to the knowledge store. An instance of the knowledge service is created. The instance of the knowledge service performs operations on the data records.

Certain embodiments of the invention may provide one or more technical advantages. A technical advantage of one embodiment may be the capability to provide a service-oriented approach to distributing knowledge stores. Yet other technical advantages may include the capability to install a set of basic services to support a knowledge federation. Yet other technical advantages may include the capability to control and monitor operation of a knowledge federation.

Various embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 presents a knowledge management environment according to one embodiment;

FIG. 2 presents a multi-node knowledge management environment according to one embodiment;

FIG. 3 presents a method for controlling the lifecycle of an instance of a service;

FIG. 4 presents one embodiment of a method for managing a knowledge store environment; and

FIG. 5 presents an embodiment of a general purpose computer operable to perform one or more operations of various embodiments of the invention.

### DETAILED DESCRIPTION OF THE DRAWINGS

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

A knowledge store may include any physical knowledge stores capable of storing a structured collection of data records. The data records may represent a conceptual description or modeling of information. Embodiments of the data records may be defined according to a semantic data model. A semantic data model is a data-modeling technique to define the meaning of data within the context of its interrelationships with other data.

In some embodiments, the data records may be defined as a Resource Description Framework (RDF) expression. An example of an RDF expression is an RDF triple, which describes data in the form of a subject-predicate-object expression. The subject denotes the resource. The predicate denotes traits or aspects of the resource and expresses a relationship between the subject and the object. For example, the notion “the sky has the color blue” may be expressed as an RDF triple: a subject denoting “the sky,” a predicate denoting “has the color,” and an object denoting “blue.”

A collection of RDF statements may resemble a labeled graph under graph theory. A graph is an abstraction of relationships among objects. A graph includes two or more nodes and one or more edges connecting the nodes. Graph labeling refers to the assignment of unique labels to the edges and nodes of a graph. A subgraph is a graph whose node set is a subset of another graph.

Collections of the data records may be accessed using a query executed using a query language. In several embodiments, queries may be executed to retrieve the data records 112 according to an RDF query language such as SPARQL Protocol and RDF Query Language (“SPARQL”). Other examples of a query language may include RDF query language (RDQL), Versa, and XML User Interface Language (XUL).

A query of RDF expressions may contain a set of triple patterns. A triple pattern resembles an RDF triple. However, the subject, predicate, and object of a triple pattern may be a variable. In a query, the triple pattern matches the RDF expression when the terms of the RDF triple may be substituted for the variables of the triple pattern. In some embodiments, queries may also include groups of triple patterns, and some of the triple patterns may include variables that relate to one another. In some embodiments, queries may also include complex filters, aggregation statements, sorting statements optional patterns, and such.

The knowledge store may include multiple physical knowledge stores arranged in a distributed knowledge store environment. However, fielded instances of distributed knowledge stores are rare. In some instances, distributed knowledge stores may lack practical tools for an enterprise framework. Accordingly, teachings of certain embodiments recognize the use of a service-oriented cluster of knowledge stores. Teachings of certain embodiments also recognize the ability to create, configure, and monitor the operation of knowledge components individually and collectively. Teachings of certain embodiments also recognize the ability to implement a service-oriented framework in runtime.

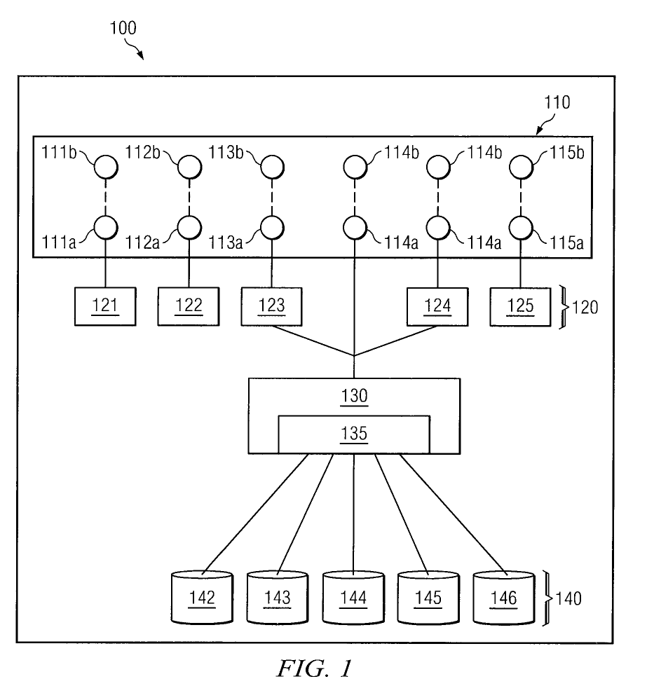

FIG. 1 presents a knowledge management environment 100 according to one embodiment. The knowledge management environment 100 features a management agent 110, management services 120, a knowledge management service 130, a knowledge service 135, and physical stores 140.

The management agent 110 illustrated in FIG. 1 features service components 111a-115a and configuration components 111b-115b. In the embodiment illustrated in FIG. 1, the five service components 111a-115a correspond to the five configuration components 111b-115b. Other embodiments of the knowledge management environment 100 may feature more, less, or different service components and configuration components. Some embodiments of the knowledge management environment 100 may include an interface in communication with the management agent 110 that allows a user to configure and manage the service components 111a-115a and the configuration components 111b-115b.

In some embodiments, the service components 111a-115 and the configuration components 111b-115b may be represented by Java managed beans. Teachings of certain embodiments recognize that the use of Java managed beans may allow the knowledge management environment 100 to incorporate functionality from Java Management Extensions technology. Java Management Extensions is a toolkit for building distributed, web-based, dynamic solutions for managing and monitoring applications and service-driven networks. However, embodiments of the service components 110a-115a and the configuration components 110b-115b are not limited to Java managed beans, but may be represented as components in any suitable form.

Each of the service components 110a-115a may be operable to communicate with the management services 120. In the embodiment illustrated in FIG. 1, the knowledge management environment 100 features five management services 121-125. Other embodiments of the knowledge management environment 100 may feature more, less, or different management services.

In the embodiment illustrated in FIG. 1, the components 111a communicates with a lookup service 121. The lookup service 121 provides a registry in which service providers may advertise their services, and clients (as well as other services) may locate and enlist the help of those services. The components 112a communicates with a class definition service 122. The class definition service 122 furnishes current class definition files to the lookup service 121 and other components wishing to obtain the most current class files. For example, an application may deploy new code by downloading class definitions from the class definition service 122.

In some embodiments, the lookup service 121 and the class definition service 122 may incorporate functionality from Apache River (formerly known as “Jini”). In some embodiments, Apache River may be incorporated to provide a service-oriented architecture that enables construction of secure, adaptive, distributed systems with federations of services and clients. For example, in some embodiments, the lookup service 121 may incorporate the Registrar from Apache River to provide service-discovery functionality.

In the embodiment illustrated in FIG. 1, the components 113a communicates with a model definition service 123. The model definition service 123 provides a set of distributed knowledge store models that may define specific, unique configurations of knowledge clusters and services. The models may specify the service composition, assignment of services to hosts, and connection details so that the cluster may be formed and configured into a network. The models may include both user-created models and default models.

In the embodiment illustrated in FIG. 1, the components 114a communicates with an authentication service 124. The authentication service 124 may provide user validation for other components that require authentication. For example, a service request submitted to one of the management services 120 may include an authentication token; the service receiving the service request may validate the authentication token with the authentication service 124 and then either allow or deny the service request. If the service then attempts to pass the service request to more services, the service may pass the user validation with the service request.

In the embodiment illustrated in FIG. 1, the components 115a communicates with a logging service 125. The logging service 125 provides a common logging mechanism for the management services 120 and the management agent 110. The logging service may log activities such as storing, retrieving, and filtering.

In some embodiments, the management agent 110 may invoke the logging service 125 to collect and report operating statistics, monitor the status and health of the management 120, and provide failure detection capability. For example, the logging service 125 may collect statistics regarding knowledge store functionality. Examples include the estimated size of physical knowledge stores within the environment; average find operations performed per second over some configurable time period; and average data records per second loaded over some configurable time period. Available statistics may also include system load average, memory usage, garbage collection time, and available disk space.

In addition, the logging service 125 may return health-status reports. For example, in one embodiment, a red-yellow-green light system may return a health-status report: a green light signifies that the system is operating normally with no known impending problems; a yellow light signifies that the system is operating normally but with potential impending failures detected; and a red light signifies that the system is no longer operating normally. The health-status reports may be tied to failure-detection operations. For example, the logging service 125 may report a potential failure when the knowledge store is almost full, the physical storage is almost full, or a component is no longer communicating with the system.

In some embodiments, the knowledge management service 130 and the knowledge service 135 provide a mechanism for communicating with one or more knowledge stores 140. For example, in one embodiment, the management agent 110 may manage the knowledge stores 140 through the knowledge management service 130. In this embodiment, the knowledge management service 130 represents the knowledge stores 140 to the management agent 110.

In some embodiments, examples of the knowledge service 135 may include a distributed graph service, a distributed knowledge service, a reasoning service, and a query service. The distributed graph service creates a root node in the collection of knowledge services, which provides a single point of access to a distributed knowledge system. The distributed graph service exposes a multi-store, or multi-node, knowledge system externally as a single knowledge store. The reasoning service executes a rule across multiple graphs and adds the resulting data records into a specified target graph. The query service offers an access point to manage and prioritize knowledge store queries.

In the embodiment illustrated in FIG. 1, knowledge management environment 100 features six knowledge stores 140, labeled as physical knowledge stores 142-146.

In the illustrated embodiment, the physical knowledge store 142 represents an assertions store. The assertions store provides a set of known facts or statements that have been asserted to be true according to some data source or user. These are the base statements of fact from which additional knowledge may be derived.

In the illustrated embodiment, the physical knowledge store 143 represents an inferences store. The inferences store provides storage for statements that are derived from the assertions in the assertion store via rules in a rules store in combination with the ontological statements in an ontology store.

In the illustrated embodiment, the physical knowledge store 144 represents a reification store. The reification store provides storage for reification statements about the fact in the assertion store. Reification statements may include, but are not limited to, statements about the validity, source, reliability, assertion date, etc. Teachings of certain embodiments recognize that storing reification statements in a separate reification store may improve performance.

In the illustrated embodiment, the physical knowledge store 145 represents a rules store. The rules store provides a set of complex inference rules in some rule language that can be executed against the assertion and the aggregate ontology stores to produce derived information for the inference store.

The physical knowledge store 146 represents an ontology store. An ontology may include any formal representation of a set of concepts within a domain, the properties of those concepts, and the relationships between those concepts. The concepts may classify instances of the concepts, other concepts, or a combination of both. In some embodiments, the instances may be stored as data records in the knowledge store 170. In these embodiments, the ontologies provide a shared vocabulary for the data records.

For example, an ontology may define a concept “car.” One instance of a car is a Ford Explorer. The Ford Explorer may have several properties: a name (e.g., Ford Explorer), an engine (e.g., 4.0 liter engine), a transmission (e.g., 6-speed transmission), and an interior (e.g., leather). Instances of the concept “car” may have relationships to other instances of the concept “car.” For example, the instance Ford Explorer may have a defined relationship to its predecessor, the Ford Bronco. A concept can also subsume other concepts; for example, a concept “vehicle” may subsume the concept “car” because every instance of a car must be an instance of a vehicle. Subsumption relationships may be used to create hierarchies of concepts.

The ontologies may be encoded according to an ontology language. Two examples of an ontology language for describing RDF expressions are the Web Ontology Language (OWL) and RDF Schema. Other embodiments of the ontologies may be encoded according to other knowledge representation languages.

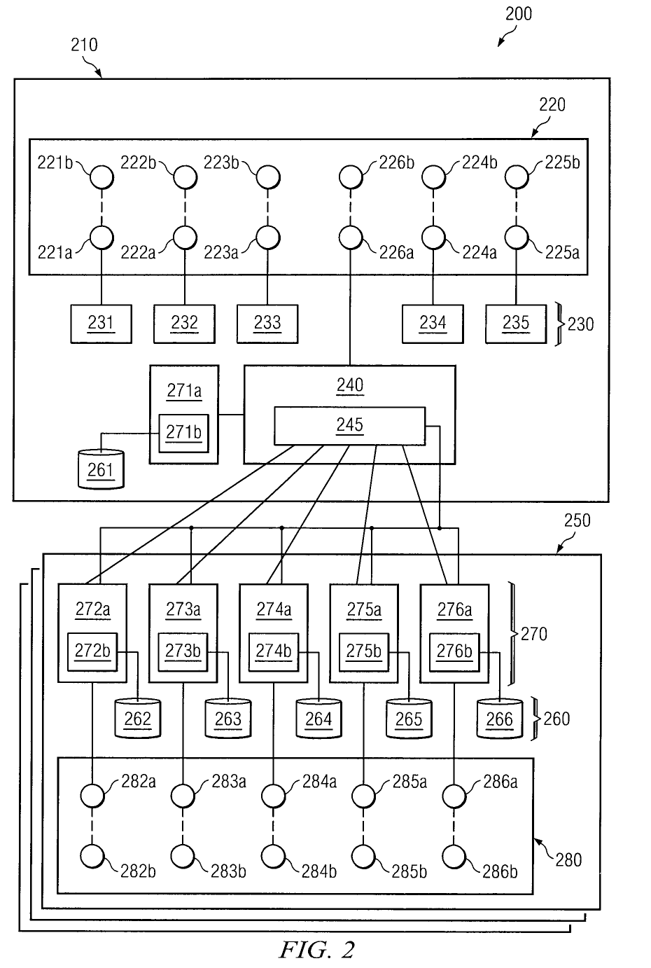

FIG. 2 presents a multi-node knowledge management environment 200 according to one embodiment. The multi-node knowledge management environment 200 features a node 210 and a node 250. The nodes 210 and 250 may represent any hosts within a distributed knowledge store. For example, in one embodiment, the node 210 or node 250 may be local to a knowledge store. In some embodiments, the node 210 and node 250 may communicate over an enterprise network; in other embodiments, the nodes 210 and 250 may communicate over a local network. Embodiments of the multi-node knowledge management environment 200 may include further nodes in addition to the nodes 210 and 250.

The node 210 features a management agent 220, management services 230, a distributed knowledge management service 240, and a distributed knowledge service 245. In the illustrated embodiment, the management agent 220 features service components 221a-225a and configuration components 221b-225b. Examples of the management agent 220, the service components 221a-225a, and the configuration components 221b-225b may include the management agent 110, the service components 111a-115a, and the configuration components 111b-115b of FIG. 1. In the illustrated embodiment, the management services 230 include management services 231-235. Examples of the management services 231-235 may include the management services 121-125 of FIG. 1. Examples of the distributed knowledge management service 240 and the distributed knowledge service 245 may include the knowledge management service 130 and the knowledge service 135 of FIG. 1.

In the embodiment illustrated in FIG. 2, the multi-node knowledge management environment 200 features six knowledge stores 260, labeled as physical knowledge stores 261-266. Examples of the physical knowledge stores 262-266 may include the physical knowledge stores 142-146 of FIG. 1. In the illustrated embodiment, the physical knowledge store 261 resides on the node 210, and the physical knowledge stores 262-266 reside on the node 250; however, embodiments of the knowledge stores 260 may reside on any node within the knowledge management environment 200.

In the illustrated embodiment, the physical knowledge store 261 represents an aggregate ontology store. An aggregate ontology store may provide common storage for pulling several ontologies from remote stores into a local store.

In the illustrated embodiment, the knowledge stores 260 are managed by knowledge services 270, labeled as local knowledge management services 271a-276a and local knowledge services 271b-276b. In some embodiments, the local knowledge management services 271a-276a may manage the local knowledge services 271b-276b. In the illustrated embodiment, the local knowledge services 271b-276b are in communication with the distributed knowledge service 245. In this embodiment, the distributed knowledge service 245 may forward service requests to the local knowledge services 271b-276b, which are local to the physical knowledge stores 260. For example, the distributed knowledge service 245 may include a distributed graph service that exposes a multi-store, or multi-node, knowledge system externally as a single knowledge store.

In the illustrated embodiment, the local knowledge management services 272a-276a are in communication with a management agent 280 residing on the node 250. In the illustrated embodiment, the management agent 280 features knowledge service components 282a-286a and knowledge configuration components 282b-286b. Other embodiments of the knowledge management environment 100 may feature more, less, or different knowledge service components and knowledge configuration components. Some embodiments of the knowledge management environment 100 may include an interface in communication with the management agent 110 that allows a user to configure and manage the knowledge service components 282a-286a and the knowledge configuration components 282b-286b.

In some embodiments, the knowledge service components 282a-286a and the knowledge configuration components 282b-286b may be represented by Java managed beans. However, embodiments of the knowledge service components 282a-286a and the knowledge configuration components 282b-286b are not limited to Java managed beans, but may be represented as components in any suitable form.

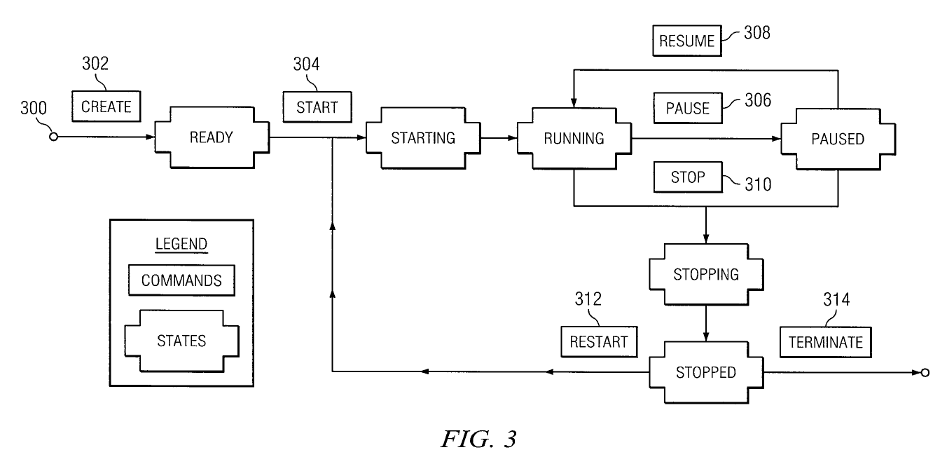

FIG. 3 presents a method for controlling the lifecycle of an instance of a service. In some embodiments, the method of FIG. 3 may be executed by a managing component. Examples of the managing component may include the service components 111a-115a, the service components 221a-225a, and the knowledge service components 282a-286a. Examples of the services of FIG. 3 may include the management services 120, the management services 230, and the knowledge services 270.

The method of FIG. 3 begins at step 300. At step 302, a create command is issued. The create command creates an instance of a service in a ready state. At step 304, a start command is issued. The start command starts the instance, resulting in the instance having a running state. At step 306, a pause command is issued. The pause command pauses the instance, resulting in the instance having a paused state. At step 308, a resume command is issued. The resume command unpauses the instance, returning the instance to the running state. At step 310, a stop command is issued. The stop command stops the instance, resulting in the instance having a stopped state. At step 312, the instance may be restarted, returning the instance to the running state. At step 314, a terminate command is issued. The terminate command terminates the instance of the service.

Embodiments of the method of FIG. 3 may include fewer, more, or different commands and states than those illustrated in FIG. 3. Additionally, the commands of FIG. 3 may be issued in any order.

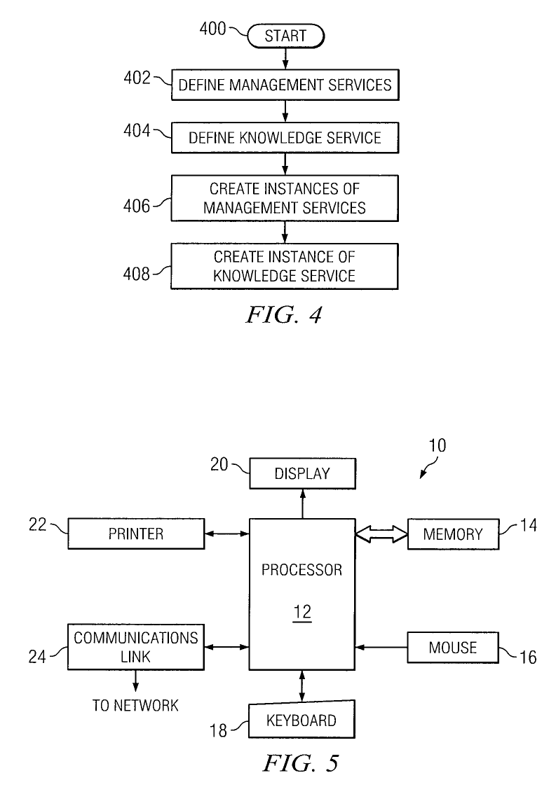

FIG. 4 presents one embodiment of a method for managing a knowledge store environment. The method of FIG. 4 may incorporate one or more components of the knowledge management environments of FIGS. 1 and 2.

The method of FIG. 4 starts at step 400. At step 402, management services are defined. Examples of the management services may include the management services 120, the management services 230, and the local knowledge management services 271a-276a. The management services may be defined according to a model. For example, the model definition service 123 may provide a set of distributed knowledge store models that defines specific, unique configurations of knowledge clusters and services.

At step 404, knowledge services are defined. Examples of the knowledge services may include the knowledge service 135, the distributed knowledge service 245, and the local knowledge services 271b-276b. The knowledge services may be defined according to a model. For example, the model definition service 123 may provide a set of distributed knowledge store models that defines specific, unique configurations of knowledge clusters and services.

At step 406, instances of the management services may be created. For example, in one embodiment, the instances of the management services may be created according to the create command of step 302. At step 408, instances of the knowledge services may be created. For example, in one embodiment, the instances of the knowledge services may be created according to the create command of step 302.

In some embodiments, the model may be validated before instances of the management services are created. For example, validation operations may include, but not limited to, checking for missing property values, checking for invalid ranges on property values, assuring that a knowledge system matches a physical deployment environment, checking for logical errors in system design (i.e., loops in distributed storage setup, missing services, etc.), or any other errors in configuration that will cause runtime problems. Teachings of certain embodiments recognize that validation may assure that the complete knowledge environment is logically consistent and matches the real deployment environment.

FIG. 5 presents an embodiment of a general purpose computer 10 operable to perform one or more operations of various embodiments of the invention. The general purpose computer 10 may generally be adapted to execute any of the well-known OS2, UNIX, Mac-OS, Linux, and Windows Operating Systems or other operating systems. The general purpose computer 10 in this embodiment comprises a processor 12, a memory 14, a mouse 16, a keyboard 18, and input/output devices such as a display 20, a printer 22, and a communications link 24. In other embodiments, the general purpose computer 10 may include more, less, or other component parts.

Several embodiments may include logic contained within a medium. Logic may include hardware, software, and/or other logic. Logic may be encoded in one or more tangible media and may perform operations when executed by a computer. Certain logic, such as the processor 12, may manage the operation of the general purpose computer 10. Examples of the processor 12 include one or more microprocessors, one or more applications, and/or other logic. Certain logic may include a computer program, software, computer executable instructions, and/or instructions capable being executed by the general purpose computer 10. In particular embodiments, the operations of the embodiments may be performed by one or more computer readable media storing, embodied with, and/or encoded with a computer program and/or having a stored and/or an encoded computer program. The logic may also be embedded within any other suitable medium without departing from the scope of the invention.

The logic may be stored on a medium such as the memory 14. The memory 14 may comprise one or more tangible, computer-readable, and/or computer-executable storage medium. Examples of the memory 14 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

The communications link 24 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding.

Although the illustrated embodiment provides one embodiment of a computer that may be used with other embodiments of the invention, such other embodiments may additionally utilize computers other than general purpose computers as well as general purpose computers without conventional operating systems. Additionally, embodiments of the invention may also employ multiple general purpose computers 10 or other computers networked together in a computer network. For example, multiple general purpose computers 10 or other computers may be networked through the Internet and/or in a client server network. Embodiments of the invention may also be used with a combination of separate computer networks each linked together by a private or a public network.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

What is claimed is:

1. A computer-readable medium having computer-executable instructions, when executed by a computer configured to:
define a plurality of management services according to a model, the model structuring operations among the plurality of management services according to a knowledge configuration;
define a knowledge service according to the model, the model assigning the knowledge service to a knowledge store according to the knowledge configuration, the knowledge store comprising a plurality of data records;
create instances of the plurality of management services, the instances of the plurality of management services operable to control access to the knowledge store; and
create an instance of the knowledge service, the instance of the knowledge service operable to perform operations on the data records.

2. The computer-readable medium of claim 1, wherein the data records are Resource Description Framework (RDF) expressions.

3. The computer-readable medium of claim 1, the instructions when executed further configured to create instances of the plurality of management services on the knowledge store by providing a management agent, the management agent comprising a plurality of management components, the plurality of management components operable to create the instances of the plurality of management services.

4. The computer-readable medium of claim 3, the instructions when executed further configured to provide a user interface in communication with the management agent, the user interface operable to configure the management services through management components.

5. The computer-readable medium of claim 1, wherein the knowledge store comprises a plurality of physical knowledge stores, the instructions when executed further configured to define a knowledge service according to the model by defining a plurality of knowledge service according to the model, the model assigning the plurality of knowledge services to the plurality of physical knowledge stores according to the knowledge configuration.

6. The computer-readable medium of claim 5, wherein the plurality of physical knowledge stores communicate across two or more network domains.

7. The computer-readable medium of claim 6, wherein the set of the management services on each of the plurality of physical knowledge stores are operable to limit access to the data records across the two or more network domains.

8. The computer-readable medium of claim 5, wherein the plurality of management services comprises a distributed knowledge service, the distributed knowledge service representing the plurality of physical knowledge as a distributed knowledge store with a single point of access.

9. The computer-readable medium of claim 1, wherein the plurality of management services the instructions when executed further configured to measure performance statistics of the knowledge store.

10. The computer-readable medium of claim 1, wherein the plurality of management services the instructions when executed further configured to detect a knowledge store failure.

11. A method for managing a knowledge store environment, comprising:
using a computer system, defining a plurality of management services according to a model, the model structuring operations among the plurality of management services according to a knowledge configuration;
using a computer system, defining a knowledge service according to the model, the model assigning the knowledge service to a knowledge store according to the knowledge configuration, the knowledge store comprising a plurality of data records;
using a computer system, creating instances of the plurality of management services, the instances of the plurality of management services operable to control access to the knowledge store; and
using a computer system, creating an instance of the knowledge service, the instance of the knowledge service operable to perform operations on the data records.

12. The method of claim 11, wherein the data records are RDF expressions.

13. The method of claim 11, wherein creating instances of the plurality of management services on the knowledge store comprises:
providing a management agent, the management agent comprising a plurality of management components, the plurality of management components operable to create the instances of the plurality of management services.

14. The method of claim 13, further comprising providing a user interface in communication with the management agent, the user interface operable to configure the management services through management components.

15. The method of claim 11, wherein the knowledge store comprises a plurality of physical knowledge stores, wherein the defining a knowledge service according to the model comprises:
defining a plurality of knowledge service according to the model, the model assigning the plurality of knowledge services to the plurality of physical knowledge stores according to the knowledge configuration.

16. The method of claim 15, wherein the plurality of physical knowledge stores communicate across two or more network domains.

17. The method of claim 16, wherein the set of the management services on each of the plurality of physical knowledge stores are operable to limit access to the data records across the two or more network domains.

18. The method of claim 15, wherein the plurality of management services comprises a distributed knowledge service, the distributed knowledge service representing the plurality of physical knowledge as a distributed knowledge store with a single point of access.

19. The computer-readable medium of claim 11, further comprising measuring performance statistics of the knowledge store.

20. The computer-readable medium of claim 11, further comprising detecting a knowledge store failure.
